(19) United States
(12) Patent Application Publication
(10) Pub. No.: US 2013/0128319 A1
(43) Pub. Date: May 23, 2013

(54) Process of printing neon fluorescent offset printing ink(s) in solids and very light densities as an economical means to create overt and covert fluorescent patterns/messages to be used to deter and detect counterfeiting, tampering and fraud within secure documents

(71) Applicant: Robert C. Kenehan, Lake Forest, IL (US)

(72) Inventor: Robert C. Kenehan, Lake Forest, IL (US)

(21) Appl. No.: 13/301,780

(22) Filed: Nov. 22, 2011

(51) Int. Cl. G06K 15/00

(52) U.S. Cl. 358/3.28

(57) ABSTRACT

This invention relates to economically enhancing document security on printed forms such as checks, money orders, prescription pads, grade reports etc. by the overprinting of a layer of neon fluorescent printing ink(s) in varying densities in predetermined patterns on any document where authentication and verification of the original is necessary. A new economical printing process to increase document security (from duplication, counterfeiting, tampering or washing) by the use of neon fluorescent ink(s), printed onto paper in predetermined patterns and densities, whereby allowing the design to perform dramatic transformations under ultraviolet light and through electronic scanning.

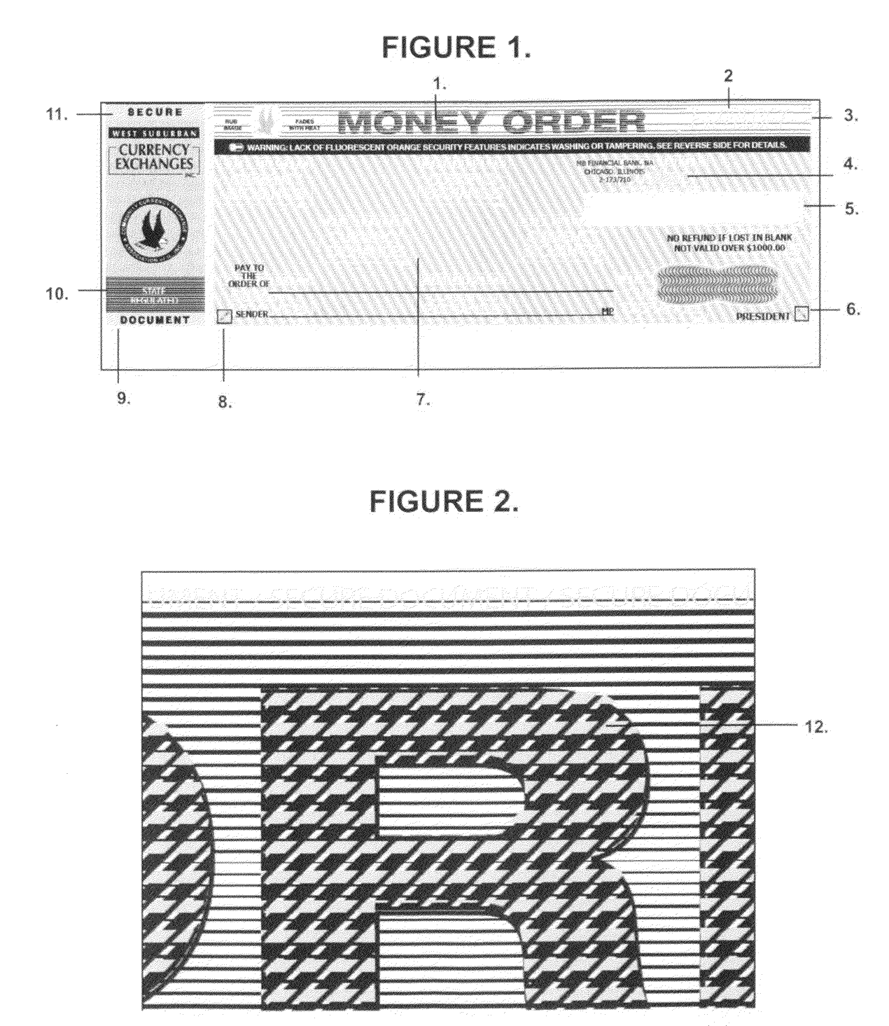

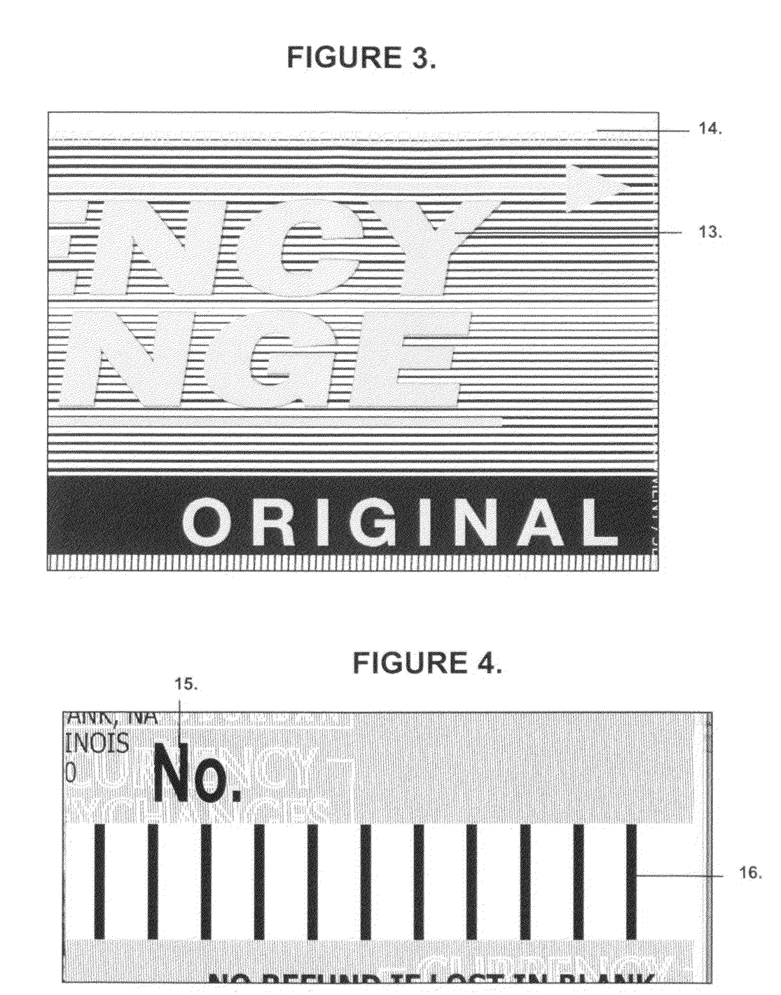

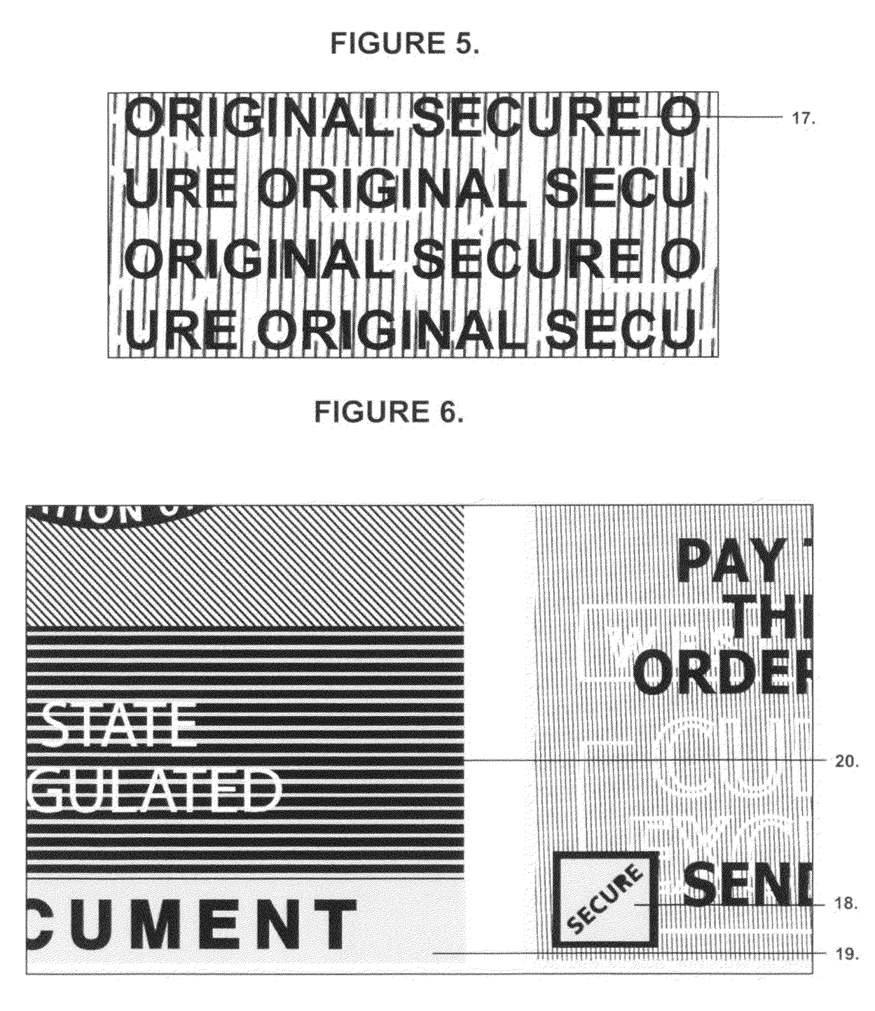

The present invention relates to a process of overprinting a neon fluorescent offset printing ink(s) (color range including PMS 801-814 in the Pantone Color Matching System™ but typically 804, 805, 810 and 811) in various patterns and densities across a secure document. Leveraging the visually bright fluorescent nature of neon ink when printing solid densities and also leveraging the UV fluorescent nature (under blacklight) of neon fluorescent ink when printing in very low densities allows for both overt and embedded covert patterns/messaging to be used as a method of verification, to deter and detect counterfeiting, tampering and fraud. And the use of neon fluorescent printing ink printed in very low densities for covert messaging is many times more cost effective than achieving the same results with invisible fluorescent inks, which are several times more expensive than neon fluorescent inks to purchase and require significantly higher print densities to elicit the same fluorescence under UV light.

The device is comprised of the following steps:
Step 1. Color Selection of printing inks of the secure document:
In addition to a base ink color(s) on a secure document, we overprint a “security layer” color(s) out of a neon fluorescent printing ink that will overprint the base color layer of non-fluorescent ink(s). We typically choose PMS 804, 805, 810 or 811 or a similar neon color that excites easily under UV light.
   This neon security layer will be integrated into the design so that the lowest density parts of the printing will be obscured or hidden until viewed under UV (black light). The security elements we design in the fluorescent overprint layer will contain as many covert and overt security elements as we can design to individually and in total deter duplication, washing and counterfeiting attempts. Since neon fluorescent offset inks can be easily printed in tandem with non-fluorescent offset printing inks using the same printing process as the base art without an additional offline process, the added security layer of neon fluorescent ink represents a very economical process to implement security features that thwart reproduction or tampering and aid in authentication of the document.
Step 2: Design features
A. Security background in neon fluorescent ink
   We design neon ink to print in light densities (3%-10% density) across the document face area in a covert step and repeat pattern. The messages are similar to ORIGINAL SECURE ORIGINAL in a step and repeat pattern in large repeating type. At a very low density 3-5%), the neon security image layer is invisible or near invisible under normal light yet highly visible under UV light. Under UV light any type of alteration, erasure, or washing will be seen within the document and will indicate tampering. Any type of digital counterfeit will not contain the same type of neon fluorescent security layer and be evident as a copy.
B. Hidden images in neon fluorescent ink
   Similar to the above, we add images or logos in addition to the messages, such as the client logo in light (3-10%) screen densities to make recreation and registration of the background difficult to replicate.
C. “Washing evident indicator” images in fluorescent ink
   Besides covert or hidden messaging, we design elements in dense solids across the face of the document to act as a visual indicator of washing attempts. Similar to how the phone industry adds a moisture sensitive PH label inside a phone to indicate water damage, we add the fluorescent printed areas to the document to indicate washing. If chemically washed, the bright fluorescent ink pigments will fade or turn to white when exposed to solvents.
D. Overprinted images in neon fluorescent ink that color shift.
   We design solid neon fluorescent lines text or images to overprint the base ink layer in patterns. When viewed under ambient light the overprinted fluorescent areas do not appear fluorescent as the base color underneath, only creates a somewhat darker overall color. When illuminated under UV light however, the overprinted fluorescent layer fluoresces in its actual hue, thereby creating a dramatic color shift from darkened base color and appears to color shift as it fluoresces in its true fluorescent color.
Step E. The indicators described in Step C along with the addition of a logo or other image printed in solid fluorescent also serves as an electronic scanning verifier. Since current black and white bank check imaging equipment sees dense fluorescent printing as “white” due to its reflective nature, it creates a “survivable image” or unique characteristic when scanned.
See drawings that indicate security feature designs printed in fluorescent ink for Steps A-E.

The necessary elements include the use of at least one neon fluorescent printing ink. The lay down of the ink is typically performed using wet offset printing technology, however other printing methods, like flexographic printing could be used to impart similar security features. Or the process could be used on blank printed papers as a base security feature, similar to artificial watermarks.

The elements or steps described above all work together as a deterrent against the four most common forms of secure document fraud, which are digital duplication, counterfeiting tampering and chemical washing. All of the processes can be accomplished using a single offset printing plate overprinting neon fluorescent ink in solids and/or very low densities to create covert and overt designs, which makes the invention extremely efficient and cost effective for offset printers. The process of offset printing hidden messages in light screen densities of neon fluorescent ink deters digital duplication as the process is not reproducible digitally and easily authenticated under UV light. The hidden low density neon screen will also show signs of tampering and washing under UV light. The process of overprinting neon fluorescent inks over standard offset inks, creating a dramatic color shifting effect, is impossible to digitally reproduce and also creates a simple means of authentication using UV light. If the document is washed, it will no longer color shift under UV light. Microprinting (the method of printing extremely small type) in neon fluorescent ink is impossible to digitally reproduce, disolves under chemical washing and is tough to counterfeit. Neon fluorescent offset printing inks in dense solids can be used to verify scanned bank documents, and will fade or dissolve under washing. All of the design processes that are offset printed in neon fluorescent ink can work independently of in conjunction. When more than one of the processes is used, it makes the document more resistant to fraud.

Under normal white light neon fluorescent offset printing inks have similar or greater visual brightness as non-fluorescent inks, however neon fluorescent inks will glow brightly under ultraviolet light whereas traditional printing ink does not. By overprinting neon fluorescent ink on top of, or next to non-fluorescent ink(s) in varying densities, I can create covert messages and designs in the document that can be revealed under UV light. Furthermore, due to the fact that the pigments used in neon fluorescent inks fade in certain chemical solvents whereas the pigments of traditional offset printing inks do not fade in the same chemical solvents, I can print using neon fluorescent inks in solid densities as an indicator of fraud by chemical tampering or washing. Unlike any other type of printing ink, including invisible UV ink, or traditional inks with UV additives, neon fluorescent ink can be designed to be printed both in strong densities for overt fraud deterrence and also in very light densities for covert deterrence and overprinted to create dramatic color shifting effects.

We design the covert messages and overprinting using desktop printing software, typically Adobe Illustrator. Output is created by computer to plate technology. Printing is typically performed on a wet offset printing press.

Color shifting technology could be adopted for currency, or packaging or labeling.

Checks, Money Orders, coupons, prescription pads, grade reports, deeds, birth certificates, train/bus passes, stock certificates, medical forms or collector cards such as baseball cards. Basically ANY secure printed item where duplication, counterfeiting or tampering is unwanted.

There are currently many printing processes for enhancing document security using UV fluorescence, including the use of invisible or clear UV printing ink that fluoresces under UV light, or adding UV fluorescence to conventional printing ink to glow under UV light. However overprinting a neon fluorescent ink(s) in both solids and/or very light densities is different and innovative in several ways and has never before been used in security printing in the same fashion for the same purpose. Our use of solids and very light densities all in one printing plate creates many security effects all in one printing pass that cannot be achieved by the use of clear UV ink or by traditional ink with UV additives. Using neither of the two commonly used methods of creating UV fluorescence in security printing have been used to perform the same multiple security effects in one printing pass that we can achieve with neon fluorescent ink namely: (1) create dramatic color shifting under UV light through overprinting neon over non-neon inks, (2) create hidden messaging by overprinting text or images in very light densities (3) add chemical washing (tampering) indicators by printing in solids and (4) and create a bank scannable survivable image all in one printing plate. And finally, we can mimic the same level of covert fluorescent security using clear UV fluorescent ink with neon fluorescent ink but at approximately 99% less ink cost. Neon style fluorescent ink has been mainly used for promotional printing where a psychedelic effect is desired. These neon fluorescent printing inks have not been used with the specific intent to create covert AND overt security features through overprinting, or to create a color shifting patterned effects on a secure printed document by leveraging the transparent nature of the neon fluorescent ink which allows the ink underneath to show through, creating a third tertiary color. The use of neon fluorescent ink printed in varying screen densities to create covert and overt security layers and tampering indicators, all contained in one printing plate, used at the time of printing the original document is extremely cost effective and efficient and unique. Invisible fluorescent ink costs approx. $100.00 US dollars per pound of ink and is typically printed at 100% densities when creating covert messaging. (The clear nature of the invisible fluorescent ink is also hard to control on press so the ink is laid down heavy to insure proper fluorescence). Conversely neon fluorescent ink costs about $30.00 US Dollars per pound and can be used to create the same fluorescent brightness under UV light by printing at a 3% density. Therefore using neon fluorescent ink offers the same effect of covert fluorescent security at ⅓ of the per pound ink cost and 1/33^{rd} of the density needed (3% vs 100%) for a net ink savings of 99% of the total ink cost. Therefore, the use of neon fluorescent ink in light densities as a covert security method will save significant amounts of money over the use of any other covert fluorescent security method.

Each year, document fraud from tampering, duplication or washing costs industry billions of dollars. Typical methods of secure document fraud include duplication using scanners and digital printing equipment, tampering, counterfeiting and washing using chemical agents. As digital printing technology advances, there is a need to develop additional methods of deterrence and verification methods to combat fraud. Duplication through digital scanning and printing poses a serious threat to secure documents. Recently, digital scanners have become so optically refined and digital printing has become so accurate that almost any type of printed image can be successfully scanned and reproduced. Fraudsters will take an original document, scan it, manipulate it digitally and then output to a digital printing device. When printed on identical paper stock, the digitally scanned and printed counterfeit can appear to be a near identical copy of the original. Check clearing methods have also changed. The majority of checks and money orders are now processed via Check 21 standards, meaning that financial documents are now image captured in black and white at the Bank of First Deposit (BOFD) or ATM and then electronically processed for payment throughout the banking system. Currently, if duplication fraud occurs at multiple BOFDs and is not detected before image capture, it is extremely difficult, if not impossible to positively verify the original from a duplicate through viewing the scanned Check 21 image(s) due to reduced resolution. Chemical alteration of secure documents is performed by washing. Washing is a process whereby a document is tampered by exposure to acetone or bleach or other solvents. Certain pen and marker inks written onto the document will dissolve with the chemical agent but leave the original printing unaffected. The challenge has been creating methods to detect and deter all types of fraud in a cost effective manner.

Neon fluorescent inks (commonly known in the Pantone Matching System™ as PMS ink colors 801-814 or Day-Glo™ inks are neon printing inks that are visually bright when viewed under ambient light but also fluoresce (glow) brightly in their same hue under UV light. I have pioneered using neon fluorescent printing ink for secure document printing by the method of printing and overprinting covert and overt images and messages in both solids and very light densities across the document. This methodology creates a new super cost effective and verifiable means to detect counterfeiting, duplication, tampering and washing attempts.
Design Methods:
A. Overprinting messages in very light screen densities of fluorescent ink is unreadable under normal lighting, but dramatically appears when viewed under UV light. Printing densities (3%-10%) of fluorescent ink is near invisible until viewed under ultraviolet light.
B. Overprinting neon fluorescent printing ink over non-fluorescent printing ink(s) creates a positive detection method for counterfeiting and/or tampering. The effect is a dramatic color shift of the overprinted image when viewed under ultraviolet light. When a non-fluorescent ink is laid down on the paper surface, and then the neon fluorescent ink is printed on top of the conventional ink, the transparency of the neon fluorescent ink on top allows the ink color beneath to show through as a combined tertiary color. Under ambient light, fluorescent overprinting appears as a blend of both ink colors and appears as a non-neon darkened version of the base color. However, when the document is viewed under UV light, the overprinted neon fluorescent ink glows brightly in its singular hue and the non-fluorescent ink remains unlit. By this process the printed image appears to “color shift” under UV light.
C. Printing solid areas of neon fluorescent ink on documents creates a means for positive electronic verification with bank scanning equipment. Neon fluorescent printing inks have reflective qualities that trick bank imaging equipment to not “see” the fluorescent printed areas of the document. They show “white. My process of using neon fluorescent ink in solids and in very light densities enhances document security in a new way by: a) Providing a means to verify against unauthorized duplication or tampering of a secure document by printing covert messages in very light screen densities of neon fluorescent colors that remain unreadable under normal viewing, but dramatically appear under examination using ultraviolet light. (b) Providing a means to verify against unauthorized duplication or tampering of a secure document by overprinting messages and/or patterns using a neon fluorescent color directly printing over a non-fluorescent printed image or type whereby the combined color appears non-fluorescent under normal viewing, but appears fluorescent under examination using ultraviolet light, creating a dramatic visual color shift. (c) Providing a means of positive verification of financial document images (Check21) whereby solid printed areas of fluorescent ink on a document will drop out as white areas on image capture, creating the possibility of electronic verification of an original document. (d) Providing a means of detection against check “washing” by printing using solid images in fluorescent ink that will wash away under exposure to the chemical solvents typically used in washing documents. (e) Saving approximately 99% of the ink cost of printing covert messages in conventional invisible fluorescent inks to achieve the same effects under UV light.

What is claimed is:

1. The process of printing a neon fluorescent offset printing ink(s) in solids and very light ink densities creates both covert and overt security effects in one pass that is more cost effective than any other printing means available to add covert and/or overt UV fluorescent security to a document.

2. The process of overprinting neon fluorescent offset printing ink(s) in solids and/or very light densities creates overt and covert hidden patterns/messages that will appear to color shift under UV light and can be used to deter and detect counterfeiting, tampering and fraud within secure documents.

3. The process of printing a neon fluorescent offset printing ink(s) in solids can create survivable images that bank imaging equipment can detect
